(19) United States
(12) Patent Application Publication
(10) Pub. No.: US 2011/0194146 A1
(43) Pub. Date: Aug. 11, 2011

(54) PRINT JOB MANAGEMENT APPARATUS, PRINT JOB MANAGEMENT METHOD, AND IMAGE FORMING APPARATUS

(75) Inventor: Eiichi Sato, Yokohama-shi (JP)

(73) Assignee: CANON KABUSHIKI KAISHA, Tokyo (JP)

(21) Appl. No.: 13/008,710

(22) Filed: Jan. 18, 2011

(30) Foreign Application Priority Data
Feb. 10, 2010 (JP) 2010-028211

(51) Int. Cl. G06F 3/12

(52) U.S. Cl. 358/1.15

(57) ABSTRACT

The printing order is controlled so that printouts are obtained from an image forming apparatus in the order in which the printing client transmitted print jobs. For this purpose, a print job received by the image forming apparatus is captured at the communication packet level and the date & time of starting reception of the print job is managed in a job list. When a print job of interest is input to a print queue manager, it is determined whether there is a previously input job, reception of which has not completed. If so, the previously input job is waited, and when the previously input job is input entirely, the previously input job is registered in a print queue. Subsequently, the print job of interest is registered in the print queue.

### BACKGROUND OF THE INVENTION

1. Field of the Invention

The present invention relates to a print job management apparatus, print job management method, and image forming apparatus to guarantee that, for example, printouts are obtained from the image forming apparatus in the order in which the printing client apparatus transmitted print jobs.

2. Description of the Related Art

As a conventional technique to guarantee print order, a reception-completed print job is added to the end of an integrated processing queue, and printout starts in the order in which an image forming apparatus received print jobs (see, for example, Japanese Patent Laid-Open No. 2007-156532).

In this conventional technique, print jobs are scheduled as they complete receiving them, so the printout order does not always coincide with the order in which the printing client started transmitting the print jobs. In some cases, a subsequent job, printing of which has been designated later by the printing client, passes a preceding job, printing of which has been designated first, and the subsequent job is printed first. This phenomenon is highly likely to occur when the image forming apparatus supports multi-session connection and the data size of a subsequent job is much smaller than that of a preceding job.

### SUMMARY OF THE INVENTION

The present invention has been made in consideration of the above situation, and provides an image forming apparatus which can asynchronously receive a plurality of jobs and executes print jobs in the order of corresponding print instructions, and a printing control method therefor.

The present invention further provides a print job management apparatus, print job management method, and image forming apparatus capable of executing print jobs from a given source in the order of corresponding print instructions, and preventing the interrupt of a print job from a different source.

The present invention has the following arrangement.

According to one aspect of the present invention, a print job management apparatus capable of parallel-receiving, via a plurality of connections, communication packets which form a print job, the apparatus comprises: a queue management unit, configured to register print jobs in a print job queue in an order in which communication packets each indicating a start of a print job have been received; and an output unit, configured to output the print jobs in an order in which the print jobs have been registered in the print job queue by the queue management unit.

According to the present invention, it can be controlled to save print jobs in the print queue in the reception start order. Even when reception of a subsequent job is completed before a preceding job, printouts can be obtained in the order in which the printing client transmitted print jobs.

Further features of the present invention will become apparent from the following description of exemplary embodiments with reference to the attached drawings.

### BRIEF DESCRIPTION OF THE DRAWINGS

FIG. 1 is a block diagram showing the data flow in an image forming apparatus;

FIG. 2 is a view showing the configuration of a printing system;

FIG. 3 is a flowchart showing job list generation processing;

FIG. 4 is a table showing the structure of a job list;

FIG. 5 is a flowchart showing print queue management processing;

FIG. 6 is a view showing the UI of a printer setting means;

FIG. 7 is a block diagram showing the hardware of the image forming apparatus; and

FIG. 8 is a flowchart showing print job scheduling processing in the second embodiment.

### DESCRIPTION OF THE EMBODIMENTS

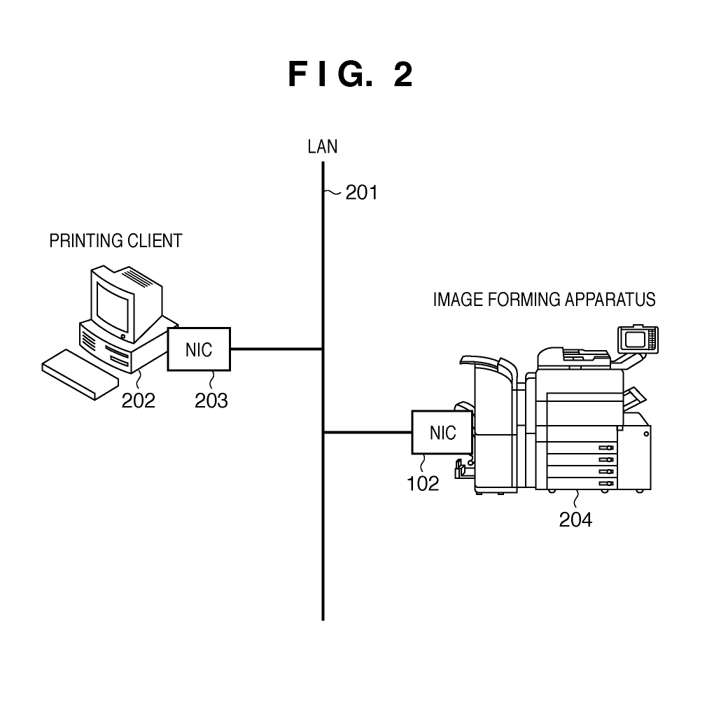

Preferred embodiments of the present invention will now be described with reference to the accompanying drawings. FIG. 2 is a view showing the configuration of a printing system according to the present invention. Referring to FIG. 2, a LAN (Local Area Network) 201 is a network communication medium such as Ethernet®. A printing client 202 is connected to the LAN 201 via a NIC (Network Interface Card) 203. The printing client is, for example, a computer in which an application program having a printing function including document processing and image processing is installed. An image forming apparatus 204 having a function of receiving a print job transmitted from the printing client 202 and printing on a printing medium is also connected to the LAN 201 via a NIC 102. The image forming apparatus is, for example, a multi-functional copying machine or printer, and has a function of receiving a print job from the printing client and executing it. In this configuration, the printing client 202 can transmit a print job to the image forming apparatus 204 via the LAN 201. In this embodiment, the network system is a TCP/IP network, and data which form a print job are transmitted for each message, packet, or frame in accordance with procedures determined by each protocol layer. When a plurality of printing clients 202 exist, each client is connected to the image forming apparatus 204 via the TCP connection for each client. Further, the amount of print data is generally large and the order of print data is important. In the embodiment, therefore, the application layer protocol supports a session. One print job is transmitted from the printing client 202 to the image forming apparatus 204 by one session. It is also possible that the printing server provides the above-described functions regarding the communication protocol of the image forming apparatus in the embodiment, and the image forming apparatus itself is connected to the printing server via a serial I/F or parallel I/F and provides only the printing function.

The print job is a unit of processing that is generated in correspondence with, for example, one print instruction when an application program or the like in the printing client designates printing. The print job contains a job header which defines the job, and print data to be processed by the image forming apparatus. For example, when the operator inputs a print instruction to an application program running on the printing client, the application calls a function provided by the operating system, and transfers data to be printed to the operating system. By using a driver program provided by the vender of the image forming apparatus or the like, the operating system converts the data to be printed into print data of a format which can be interpreted and executed by the image forming apparatus. The operating system generates a print job containing the print data, and transmits it to the image forming apparatus. Although the transmission of the print job may start upon completion of generating the print job, the first packet may be transmitted in response to a print instruction before the completion of generating the print data.

Hardware of Image Forming Apparatus>

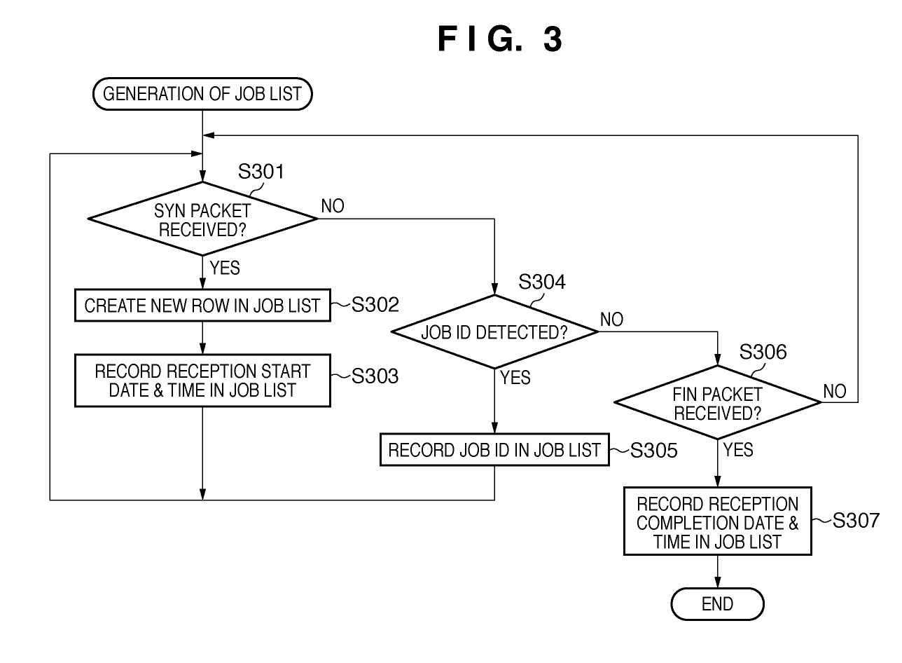

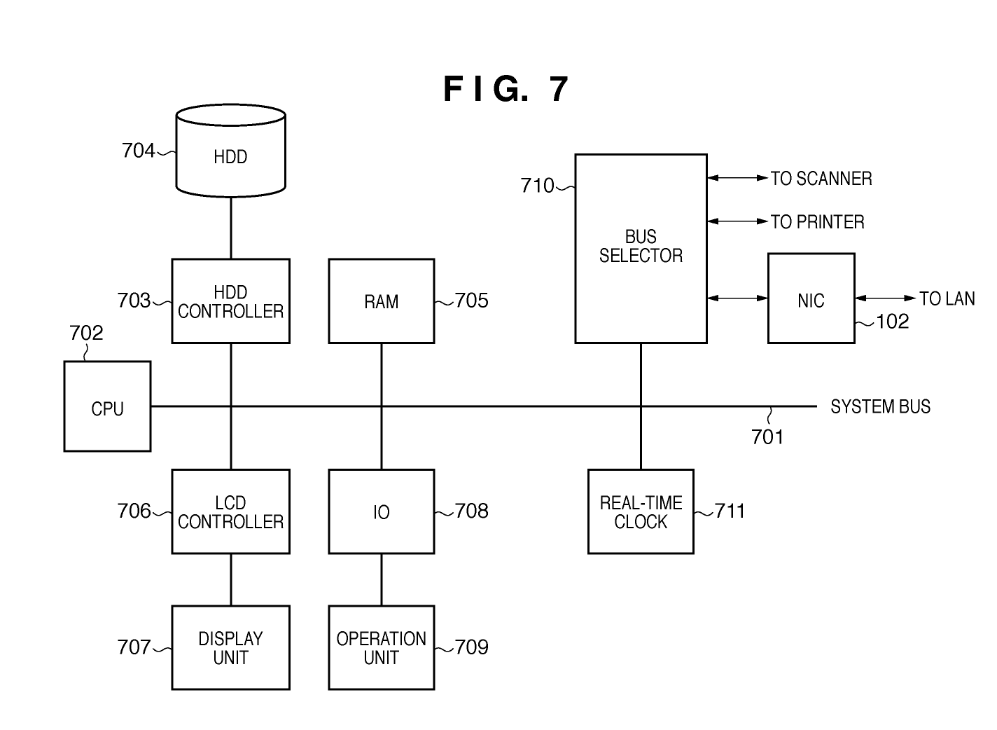

FIG. 7 is a block diagram showing the hardware of the image forming apparatus 204 according to the present invention. Referring to FIG. 7, a CPU 702 controls the image forming apparatus in the present invention. The CPU 702 implements even the processes of flowcharts in FIGS. 3, 5, and 8 (to be described later) and the like by executing programs. An HDD controller 703 controls read/write from/in an HDD (Hard Disk Drive) 704. The HDD 704 saves programs to be executed by the CPU 702, and is also used as a large-capacity data save area. A RAM 705 is a memory for temporarily storing programs and data to be accessed by the CPU 702. An LCD controller 706 controls display on an LCD used as a display unit 707. The LCD 707 is a display unit for providing information to the user. An IO 708 controls input and output of data and is connected to an operation unit 709. The operation unit 709 accepts an instruction from the user. A bus selector 710 controls communication between an external bus and a system bus 701. A real-time clock (RTC) 711 is a timepiece for managing the time of the image forming apparatus. The CPU 702 can access the RTC 711 to read out the current date & time.

Data Flow in Image Forming Apparatus>

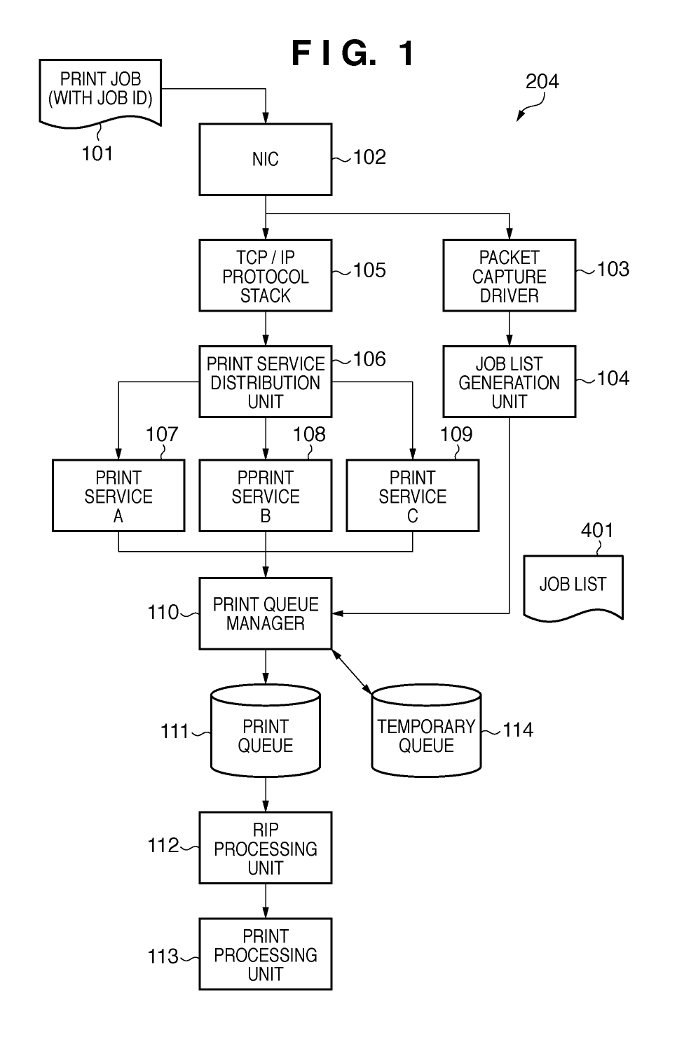

FIG. 1 is a block diagram showing the data flow in the image forming apparatus 204 according to the present invention. Referring to FIG. 1, the printing client 202 transmits a print job 101. The NIC 102 is used to connect the image forming apparatus 204 to the LAN 201. A packet capture driver 103 captures a communication packet received by the NIC 102. More specifically, the packet capture driver 103 captures a reception packet by copying it from the original processing path. A job list generation unit 104 generates a job list 401. The job list 401 includes the reception start time, reception end time, source IP address, and print service for each print job ID. A TCP/IP protocol stack 105 controls communication based on the TCP/IP protocol. A print service distribution unit 106 distributes a received print job to corresponding print services. Print services 107, 108, and 109 are supported by the image forming apparatus 204, and are, for example, an LPD print service, IPP print service, and RAW data print service. A print queue manager 110 manages queuing to control the order in which print data processed by respective print services are stored in the print queue. A print queue 111 stores print data in the printing order. A RIP processing unit 112 converts print data into raster data. A print processing unit 113 prints raster data on a printing medium such as paper. A temporary queue 114 is a storage area used when temporarily saving print data, storage of which in the print queue 111 is to wait. In FIG. 1, the building components excluding the print processing unit 113 or those excluding the RIP processing unit 112 and print processing unit 113 may be prepared not in the image forming apparatus main body but in the print server or the like. The building components in FIG. 1 except for the RIP processing unit 112 and print processing unit 113 will be called a print server or print job management unit (print job management apparatus).

A sequence until the print job 101 is printed will be explained with reference to FIGS. 1 and 2. A printer driver (not shown) running on the printing client 202 generates the print job 101. At this time, the printer driver desirably embeds a job ID in the print job in order to easily identify each job. More specifically, a tag for designating a job ID is set at the data unprinted portion of the print job 101, and a unique ID generated by a random number generation algorithm is embedded in the tag. In the embodiment, the job ID is embedded in, for example, the job header of the print job. The generated print job 101 is transmitted as communication packets by an arbitrary print service (for example, IPP) in response to a print instruction from the user of the printing client 202. The communication packets are sent from the NIC 203 to the LAN 201, received by the NIC 102, and received by the image forming apparatus 204.

The communication packets of the print job 101 that have been received by the NIC 102 are interpreted by the TCP/IP protocol stack 105, and distributed by the print service distribution unit 106 to a corresponding print service in accordance with the interpretation result. When the printing client 202 prints using print service A, the communication packets which form the print job 101 are sent to the print service A 107 (for example, IPP). The print service A 107 receives the respective communication packets in accordance with the print service protocol, and reconstructs the print job 101 sent as the packets. Upon completion of receiving all the communication packets corresponding to one print job 101 and reconstructing the print job 101, the print service A 107 sends the reconstructed print job 101 to the print queue manager 110. This also applies to another print service.

The communication packets of the print job 101 that have been received by the NIC 102 are captured by the packet capture driver 103 before sending them to the TCP/IP protocol stack 105. The packet data captured at this stage are data before TCP/IP header information is removed, so the start and end of the reception by TCP/IP can be determined. For example, the start packet of a print job is a SYN packet (establishment packet) for establishing a TCP connection to transmit the print job. A packet for releasing the TCP connection is a FIN packet (release packet). The captured packet data is analyzed by the job list generation unit 104 and used to generate the job list 401. After establishing TCP connections with respective clients, the image forming apparatus 204 can parallel-receive a plurality of print jobs from a plurality of clients via these TCP connections. The TCP connection can also be established for each program in one client. In this case, one client may parallel-transmit a plurality of print jobs.

Generation of Job List>

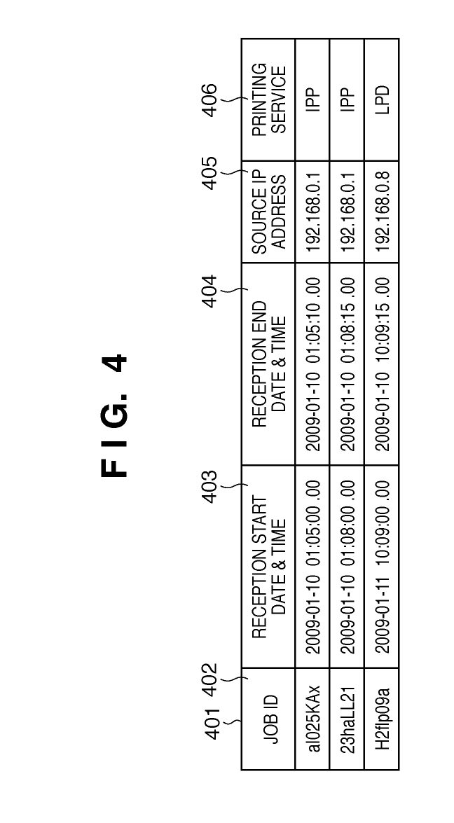

A job list generation sequence executed by the job list generation unit 104 will be described with reference to FIGS. 3 and 4. The procedures in FIG. 3 are executed every time the packet capture driver 103 captures a received packet.

To establish a TCP connection, the TCP/IP protocol first performs the handshake using the SYN packet. The CPU 702 captures the SYN packet received by the NIC 102 and uses it to determine the start of receiving the print job 101. The CPU 702 waits for reception of the SYN packet (step S301), and if the reception of the SYN packet is detected, generates a new row in the job list 401 (step S302). At this time, the CPU 702 acquires date & time information from the real-time clock 711, and records it as the reception start date & time in the job list 401 (step S303).

The CPU 702 waits for detection of a job ID from a subsequently received communication packet (step S304). Since the job ID is embedded in the print job 101, the CPU 702 detects a tag which designates the job ID, extracts ID information embedded in the tag, and records it in the job list 401 in correspondence with the reception start date & time (step S305). The correspondence is determined by, for example, the identity of the connection ID.

To release the TCP connection, the TCP/IP protocol performs the handshake using the FIN packet. The CPU 702 detects reception of the FIN packet and uses it to determine the completion of receiving the print job 101. The CPU 702 waits for reception of the FIN packet (step S306), and if the reception of the FIN packet is detected, records a date & time acquired from the real-time clock 711 as the reception end date & time in the job list 401 (step S307). In addition to these pieces of information, the CPU 702 also records, in the job list 401, the source IP address of the print job 101 that can be extracted from the communication packet, and the protocol of the print service used in communication.

The job list 401 is an example of a job list generated in the above manner. A job ID 402 is a column in which the job ID is recorded. A reception start date & time 403 is a column in which the reception start date & time of a print job 101 corresponding to each job ID is recorded. A reception end date & time 404 is a column in which the reception end date & time of a print job 101 corresponding to each job ID is recorded. A source IP address 405 is a column in which the source IP address of the print job 101 is recorded. A print service 406 is a column in which a print service used to communicate the print job 101 is recorded. Note that the CPU 702 stores the job list 401 in the storage area of the RAM 705. The CPU 702 uses the job list 401 generated by the job list generation unit 104 for the print queue manager 110. The source IP address 405 and print service 406 are referred to in print processing in a source address fixing mode and print service fixing mode, respectively.

Scheduling of Print Job>

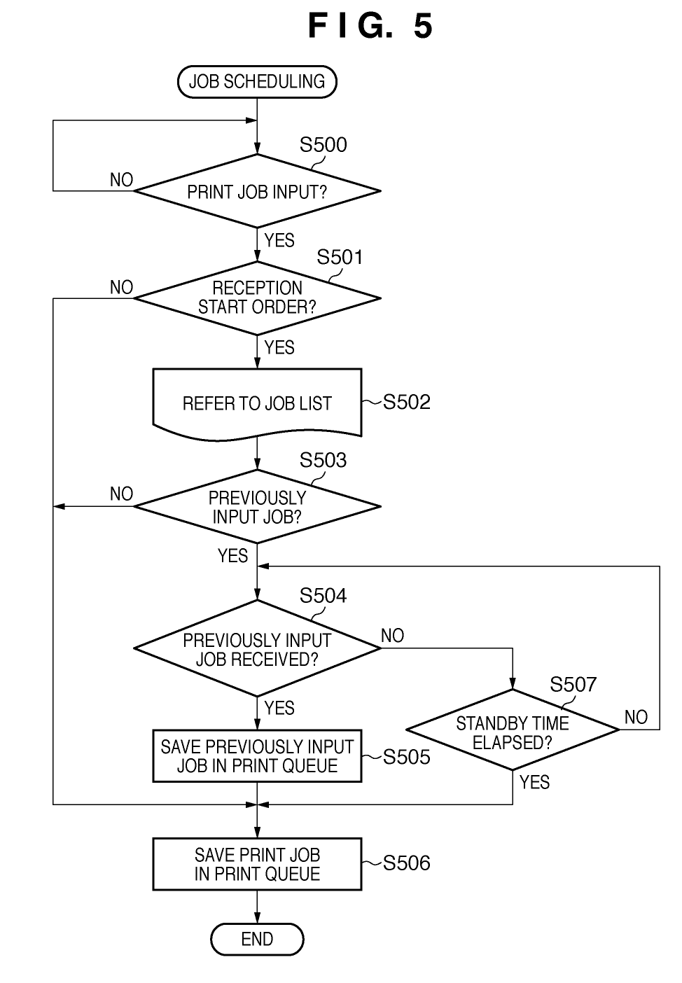

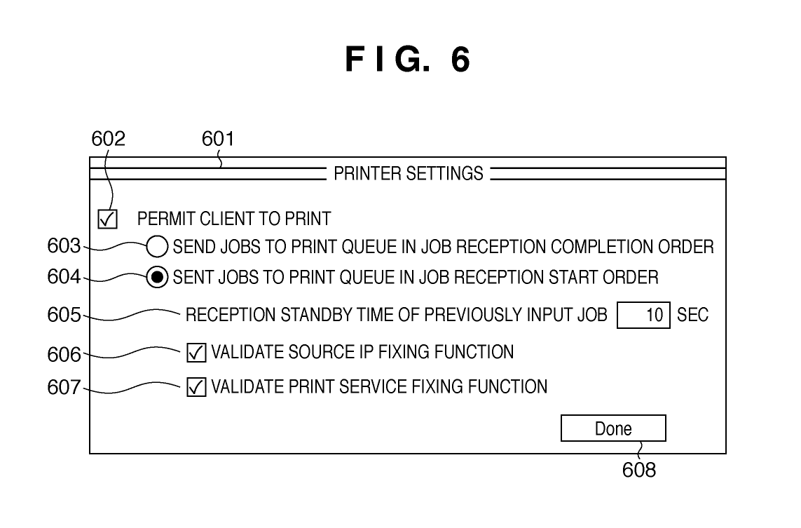

The operation sequence of the CPU 702 that is executed by the print queue manager 110 will be explained with reference to FIG. 5. The CPU 702 waits for input of the print job 101 from the print service A 107, print service B 108, or print service C 109 (step S500). A print job, reception of which has ended, is input to the print queue manager 110. This print job will be called an input print job or a print job of interest. If the CPU 702 detects input of a print job from the print service (for example, the print service A 107), it determines whether the job execution order is the reception start order (step S501). This determination is made based on a print setting selected with a radio button 604 on the UI of FIG. 6 (to be described later). If the job execution order is the reception start order, the CPU 702 refers to the job list 401 (step S502). The CPU 702 then determines whether there is a previously input job, reception of which has started prior to the print job 101 detected in step S501, but which has not been input to the print queue manager 110 yet (step S503). If a print job whose reception start date & time is earlier than that of the print job input in step S501 and whose reception end date & time is blank is registered in the job list 401, it can be determined as a previously input job.

If the CPU 702 determines that there is no previously input job, it saves (registers) the input print job 101 in the print queue 111 (step S506), schedules the input print job, and ends the process. An entry corresponding to the scheduled print job is deleted from the job list 401. The print queue 111 resides in the storage area of the HDD 704, and the CPU 702 can read/write a print job from/in the print queue 111 by using the HDD controller 703.

If the CPU 702 determines in step S503 that there is a previously input job, it waits for input of the previously input job for a predetermined time (step S504). In step S507, the CPU 702 checks whether the standby time has elapsed. If the CPU 702 determines that the standby time has elapsed, it stops waiting for the previously input job, saves the input print job 101 in the print queue 111 (step S506), and ends the process. An entry corresponding to the scheduled print job is deleted from the job list 401. If reception of the previously input job has been detected, the CPU 702 saves the previously input job in the print queue 111 (step S505), and saves the subsequently input print job 101 in the print queue 111 (step S506). As a result, the previously input job can be scheduled to be executed before the input print job.

If the CPU 702 determines in step S501 that the job execution order is not the reception start order, the print job is scheduled in the reception end order. For this purpose, the process branches to step S506 to register the print job in the print job queue in the input order.

As shown in FIG. 6, there are also prepared a source IP fixing function and print service fixing function which are options for executing only a print job that satisfies a designated condition. The former is an option for restricting a print job to be executed to a print job sent from a designated source. While the source IP fixing function option is set, only print jobs having a separately designated IP address as a source are executed. Print jobs having the same IP address as a source are input in time series. Hence, it suffices to schedule such print jobs in the reception end order. For example, when discarding a print job which does not meet this condition, if the source IP fixing function is valid in step S501, the process branches to step S506. In step S506, the CPU 702 determines the validity of the source IP fixing function, and if this function is invalid, registers all input print jobs in the print queue 111. If the source IP fixing function is valid, the CPU 702 discards a print job having an undesignated source IP address. The CPU 702 sends a message to this effect to the source of the discarded print job.

In contract, when the print service fixing function is used, only print jobs in which a designated print service is a separately designated specific print service are executed. Also in this case, it suffices to perform the same processing as that for the above-mentioned source IP fixing function except that the print service is used as the restriction criterion instead of the source IP.

FIG. 6 shows a UI for making printer settings. Referring to FIG. 6, a setting UI 601 is a user interface which allows the user to set the image forming apparatus 204 (to be also referred to as a printer). The user interface screen is displayed on the display panel of the image forming apparatus 204. A check box 602 is used to control printing permission from a client such as the printing client 202. A radio button 603 is used to select to transmit the print job 101 to the print queue in the reception end order. The radio button 604 is used to select to transmit the print job 101 to the print queue in the reception start order. The user selects either the radio button 603 or 604. An input box 605 is used to designate the reception standby time of a previously input job. The time designated in the input box 605 serves as the standby time tested in step S507. A check box 606 is a UI for controlling the permission of the source IP fixing function. A check box 607 is a UI for controlling the permission of the print service fixing function. A setting completion button 608 is used to complete settings in the setting UI 601 of the printer. Note that the CPU 702 displays the setting UI 601 of the printer on the display unit 707. A user instruction is input from the operation unit 709, and the CPU 702 interprets it via the IO 708 and executes processing complying with the user instruction.

Settings input via the user interface are saved as part of setting information in the image forming apparatus 204 and referred to. The user can select either the radio button 603 or 604 to validate/invalidate the function of sending the print job 101 to the print queue in the reception start order of the print job 101. Although the standby time of a preceding job during which the process waits in step S507 of FIG. 5 may be a fixed time, the user can set an arbitrary standby time by setting the input box 605. Efficient print processing can be implemented by adjusting this value in accordance with the network environment of the user, the size ratio of print jobs transmitted from the user, and the like.

As described above with reference to FIG. 5, the source IP fixing function is a function of fixing the printing order to print jobs sent from a specific IP address. When a plurality of printing clients simultaneously transmit a plurality of print jobs, this function becomes valid to control not to mix a job from a different printing client in printouts from the image forming apparatus 204. In the description of FIG. 5, a print job which does not satisfy a designated condition is discarded for descriptive convenience, but may wait. In this case, immediately after step S500 or if NO in step S501, the validity of the fixing function is determined. If the fixing function is invalid, the process in FIG. 5 continues. If the fixing function is valid, the source IP address information 405 of the job list 401 is referred to. If the input print job does not have the designated source IP address, it is registered in the temporary queue 114; if it has the designated source IP address, registered in the print queue 111. Upon completion of receiving print jobs from the same source IP address, the print queue manager 110 controls to read out, from the temporary queue 114, a print job sent from a different source IP address, and register it in the print queue 111. For example, when a predetermined time has elapsed after receiving the last print job from a designated source IP address, it can be determined that reception of print jobs from the same source IP address has been completed. In this case, the designated source IP address may be updated to the source IP address of a print job upon the lapse of a predetermined time after receiving the last print job.

The print service fixing function is a function of fixing the printing order to print jobs sent by a specific print service. When a plurality of printing clients transmit a plurality of print jobs using various print services, this function becomes valid to control not to mix a job from a different print service in printouts from the image forming apparatus 204. Even this function is implemented similarly to the source IP fixing function except that not the source IP address but the print service is fixed.

Print jobs registered in the print queue 111 in the foregoing procedures are output from the print queue 111 in the registration order by execution procedures performed asynchronously from the scheduling procedures. Print jobs which have been output, that is, extracted are executed in the extraction order. A print job may be extracted by, for example, the RIP processing unit 112, a scheduling module (not shown), or the print queue manager 110 using a process asynchronous from the procedures of FIG. 5.

By the above-described procedures, according to the first embodiment, print jobs can be scheduled in the order in which the image forming apparatus has received them, guaranteeing that the print jobs are output in the generation order.

### Second Embodiment

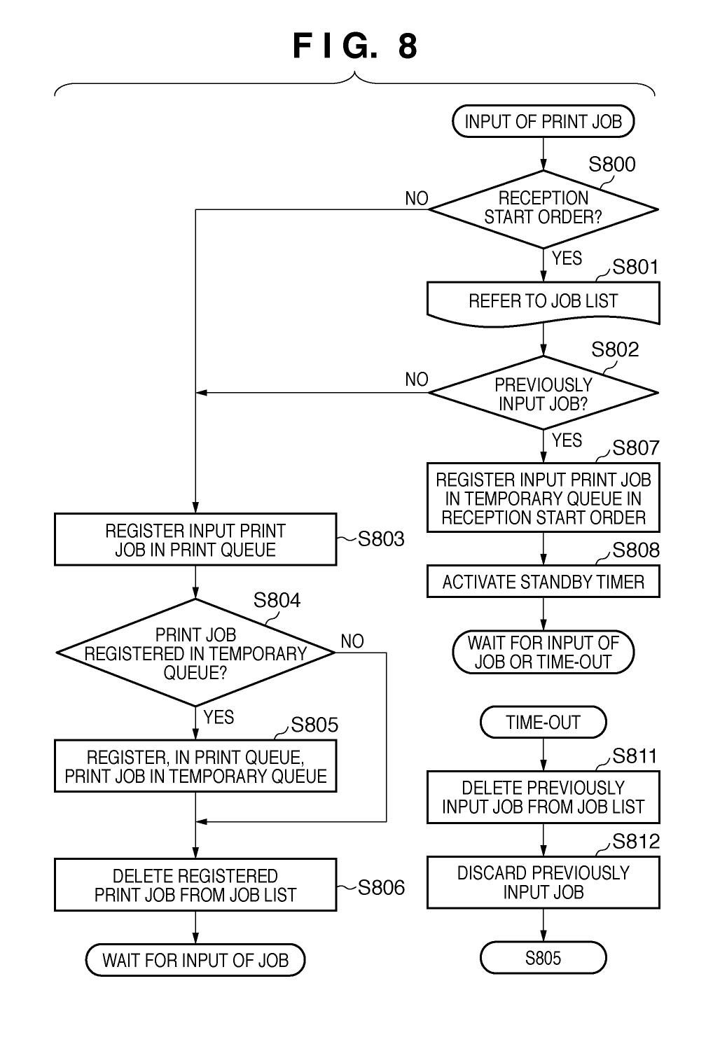

The procedures in FIG. 5 simply represent the principle of the present invention. For example, when there are a plurality of previously input jobs, the procedures are changed to those in FIG. 8. A feature of the second embodiment is to use the procedures in FIG. 8 instead of those in FIG. 5. The remaining arrangement is the same as that in the first embodiment.

Scheduling of Print Job>

The operation sequence of a CPU 702 that is executed by a print queue manager 110 will be explained with reference to FIG. 8. The sequence in FIG. 8 starts after receiving a print job 101 from a print service A 107, print service B 108, or print service C 109. First, the CPU 702 determines whether an option using the reception start order as the printing order has been set (step S800). If the printing order is the reception start order, the CPU 702 refers to a job list 401 (step S801). The CPU 702 then determines whether there is a previously input job, reception of which has started prior to the input print job 101, but which has not been input yet (step S802). If a print job whose reception start date & time is earlier than that of the input print job and whose reception end date & time is blank is registered in the job list 401, it can be determined as a previously input job.

If the CPU 702 determines that there is no previously input job, it registers the input print job 101 in a print queue 111 (step S803). The job is registered in the queue by adding it to the end of the queue. After the print job is scheduled, the CPU 702 determines whether a print job has been registered in a temporary queue 114 (step S804). If the print job has been registered in the temporary queue, the input print job is a previously input job, so the CPU 702 registers, in the print queue 111 in this order, the print job which has been registered in the temporary queue 114 (step S805). The CPU 702 deletes entries corresponding to the print jobs registered in the print queue 111 in steps S803 and S805 from the job list 401 (step S806). At this time, the standby timer which has been activated in step S808 is also canceled. After that, the CPU 702 waits for reception of a new print job.

If the CPU 702 determines in step S802 that there is a previously input job, it registers the input print job in the temporary queue 114 in the reception start order (step S807). The reception start order can be obtained by referring to, for example, the job list 401. For example, when a print job whose reception start date & time is later than that of the input print job has already been registered in the temporary queue, the input print job is registered before the print job. Thereafter, the CPU 702 activates the standby timer (step S808), and waits for input of a print job or expiration of the standby timer. The set time of the standby timer is the time designated in an input box 605 of FIG. 6.

If the CPU 702 determines in step S800 that the printing order is not the reception start order, the process advances to step S803 to schedule the input print job in the input order. In this case, no print job is registered in the temporary queue 114, and thus the process always skips step S805 and advances to step S806 after step S804.

If the standby time has exceeded the predetermined time and the standby timer has expired, that is, a time-out has occurred, the CPU 702 executes step S811. The process does not wait anymore for the previously input job suffering the time-out, and discards it to maintain the principle of executing print jobs in the reception start order. Thus, the CPU 702 deletes the entries of all previously input jobs from the job list 401 (step S811). In the second embodiment, the previously input jobs are discarded (step S812). For example, a message that printing has failed is sent to the transmitting client in step S811. Even if the packet of the discarded print job is received later, it is discarded. After step S812, there is no previously input job, input of which has not been completed, so the process branches to step S805, and the CPU 702 registers, in the print queue 111, the print job in the temporary queue 114.

By the above procedures, even when there are a plurality of previously input jobs, they can be scheduled in the reception start date & time order. When a fixing function for the source IP address or the like is used, the validity of the fixing function is determined before step S800 or after NO in step S800. If the fixing function is valid, the temporary queue 114 and print queue 111 are used separately as described in the first embodiment, and an input print job is registered. Also similar to the first embodiment, the entry of the temporary queue 114 is registered in the print queue 111.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-028211, filed Feb. 10, 2010, which is hereby incorporated by reference herein in its entirety.

What is claimed is:

1. A print job management apparatus capable of parallel-receiving, via a plurality of connections, communication packets which form a print job, the apparatus comprising:
a queue management unit, configured to register print jobs in a print job queue in an order in which communication packets each indicating a start of a print job have been received; and
an output unit, configured to output the print jobs in an order in which the print jobs have been registered in the print job queue by said queue management unit.

2. The apparatus according to claim 1, wherein
the communication packet indicting a start of a print job is an establishment packet for establishing the connection for transmitting a print job, and
when the establishment packet for establishing the connection is received, said queue management unit generates a new entry in a job list, and registers, in the entry as a reception start date & time, time when the establishment packet has been received,
when a print job ID has been received via a connection established by the establishment packet, said queue management unit registers the job ID in the job list in correspondence with the reception start date & time,
when reception of a print job of interest has ended, said queue management unit registers a communication end date & time of the print job in the job list, and determines whether a previously input job whose reception start date & time is earlier than a reception start date & time of the print job of interest and whose reception end date & time has not been registered has been registered in the job list,
when the previously input job has not been registered in the job list, said queue management unit registers the print job of interest in the print job queue, and
when the previously input job has been registered in the job list, said queue management unit waits for an end of receiving the previously input job, and when the reception ends, registers the previously input job in the print job queue, and then registers the print job of interest in the print job queue, thereby registering print jobs in the print job queue in the order in which communication packets each indicating a start of a print job have been received.

3. The apparatus according to claim 2, wherein when the previously input job includes a plurality of previously input jobs, said queue management unit waits for an end of receiving all the previously input jobs, and when the reception ends, registers the plurality of previously input jobs in the print job queue in reception start dates & time order, and then registers the print job of interest in the print job queue, thereby registering print jobs in the print job queue in the order in which communication packets each indicating a start of a print job have been received.

4. The apparatus according to claim 1, wherein the plurality of connections can be established for respective client apparatuses connected to the print job management apparatus.

5. The apparatus according to claim 1, wherein the plurality of connections can be established for each application program executed in a client apparatus connected to the print job management apparatus.

6. An image forming apparatus comprising:
a print job management apparatus according to claim 1; and
a printing unit, configured to print by executing a print job output from output means.

7. A print job management method performed by a print job management apparatus capable of parallel-receiving, via a plurality of connections, communication packets which form a print job, the method comprising:
a queue management step of registering print jobs in a print job queue in an order in which communication packets each indicating a start of a print job have been received; and
an output step of outputting the print jobs in an order in which the print jobs have been registered in the print job queue in the queue management step.

8. A non-transitory computer-readable storage medium storing a program for causing a computer to function as a print job management apparatus capable of parallel-receiving, via a plurality of connections, communication packets which form a print job, the program causing the computer to function as
queue management means for registering print jobs in a print job queue in an order in which communication packets each indicating a start of a print job have been received, and
output means for outputting the print jobs in an order in which the print jobs have been registered in the print job queue by said queue management means.
